(19) United States
(12) Patent Application Publication
(10) Pub. No.: US 2025/0272860 A1
(43) Pub. Date: Aug. 28, 2025

(54) OBJECT GROUPING FOR TIME-OF-FLIGHT RANGING ALGORITHMS

(71) Applicant: STMicroelectronics International N.V., Geneva (CH)

(72) Inventor: Edward Hawkins, Edinburgh (GB)

(21) Appl. No.: 18/584,829

(22) Filed: Feb. 22, 2024

(51) Int. Cl. G06T 7/50; G06T 5/80; G06T 7/00; G06T 7/11; G06T 7/13

(52) U.S. Cl. CPC G06T 7/50; G06T 5/80; G06T 7/0002; G06T 7/11; G06T 7/13; G06T 2207/10028

(57) ABSTRACT

According to an embodiment, a method for object abstraction to distinguish between different objects in a depth map generated from a time-of-flight sensor is proposed. The method includes conducting a raster or spiral search on the depth map. The raster search includes alternating between sweeping left to right and then up and down systematically. The spiral search includes a circumferential-direction scanning. The method further includes detecting edges of an object to guide a continuation of the raster or spiral search, calculating one or more high-level parameters related to the object, and repeating the raster or spiral search for cells of the depth map that have not been previously swept to similarly identify other objects.

### TECHNICAL FIELD

The present disclosure generally relates to electronic imaging and, in particular embodiments, to time-of-flight ranging algorithms.

### BACKGROUND

Time-of-flight (ToF) ranging devices are increasingly prevalent in applications such as autonomous vehicles, consumer electronics with gesture recognition capabilities, and 3D mapping technologies. However, their accurate performance can be significantly compromised by the generation of false targets. False targets are erroneous readings that can be mistaken for genuine objects within the device's field of view, leading to inaccurate range measurements.

The sources of false targets can be manifold, with blurring and veiling-glare of the lens being two prominent examples. Blurring occurs when the lens or foreign material on the lens causes a spreading of the light signal, leading to a diffuse reflection that lacks sharpness on the sensor. This spreading can cause readings that incorrectly suggest an object's presence or distort the actual object's perceived location.

Veiling glare is an undesirable, uniform signal that spreads across the sensor's entire field of view, often caused by reflections within the lens assembly, surrounding housing, or foreign substances such as smudges or dust. Veiling glare effectively reduces contrast and can mask or imitate the presence of real targets, thus creating false targets.

Another source of false targets arises from a mismatch between the laser pulse shape and the response from the single-photon avalanche diodes (SPADs). The long tail on a Vertical-Cavity Surface-Emitting Laser (VCSEL) pulse, in tandem with SPAD detectors, which can have after-pulsing effects, compounds this problem by creating a prolonged signal that continues beyond the actual laser pulse emission time. These prolonged signals can be misinterpreted as additional, non-existent objects.

Flickering, which occurs at the detection limits, exacerbates the problem by introducing temporal fluctuations in the measured signal. This flickering can result from various factors, such as varying reflectivity of the target surface or environmental conditions like ambient lighting changes. The resulting intermittent readings give rise to further uncertainty and false target generation.

ToF devices are designed to be highly sensitive, which, while beneficial for detecting actual targets with precision, paradoxically makes them more susceptible to these undesirable false targets. The sensitivity implies that even small signal perturbations can be detected and potentially classified as objects by the system.

### SUMMARY

Technical advantages are generally achieved by embodiments of this disclosure, which describe object grouping for time-of-flight ranging algorithms.

A first aspect relates to a method for object abstraction to distinguish between different objects in a depth map generated from a time-of-flight sensor. The method includes conducting a raster or spiral search on the depth map. The raster search systematically alternates between sweeping left to right and then up and down. The spiral search includes circumferential-direction scanning. The method further includes detecting the edges of an object to guide a continuation of the raster or spiral search, calculating one or more high-level parameters related to the object, and repeating the raster or spiral search for cells of the depth map that have not been previously swept to similarly identify other objects.

A second aspect relates to a method for pseudo-circumferential search to determine a veiling effect in a depth map generated from a time-of-flight sensor. The method includes determining a starting cell within the depth map having a maximum signal value; generating a first boundary region comprising cells adjacent to the starting cell; calculating a first ratio corresponding to a number of cells within the first boundary region having a range value within a first threshold value and a total number of cells within the first boundary region; generating a next boundary region comprising cells adjacent to the first boundary region in response to the first ratio being above a second threshold; and stopping the pseudo-circumferential search in response to the first ratio being below a second threshold, wherein the total number of cells within a penultimate boundary region is used to determine a veiling glare effect.

A third aspect relates to a method for flatness measurement to determine a veiling effect in a depth map generated from a time-of-flight sensor. The method includes determining a starting cell within the depth map having a maximum signal value; generating a first boundary region comprising cells adjacent to the starting cell; calculating a first flatness measurement for the first boundary region; generating a next boundary region comprising cells adjacent to the first boundary region; calculating a second flatness measurement for the next boundary region, wherein each flatness measurement is calculated based on a mean range value and a normalized error value for cells within a respective boundary region; and calculating a total flatness measurement to determine a veiling glare effect.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment system;

FIG. 2 is an example of a depth map from a multi-zone ToF sensor;

FIG. 3 is a flow chart of an embodiment method for grouping objects (i.e., object abstraction) using a depth map from a ToF sensor;

FIG. 4 is an implementation of the method of FIG. 3 on an exemplary depth map;

FIG. 5 is an example of a bowl from veiling glare, represented as concentric range circles;

FIG. 6 is a flow chart of an embodiment method for a pseudo-circumferential search and flatness measurement to detect veiling glare in depth map from a ToF sensor;

FIG. 7 is a plot of an embodiment range profiling to detect veiling glare;

FIG. 8 is an example of a depth map from a multi-zone ToF sensor; and

FIGS. 9a-c are a progression of a pseudo-circumferential search and flatness measurements based on the method of FIG. 6.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of time-of-flight sensors and sharpening algorithms, it should also be appreciated that they may also apply to other imaging devices and other types of algorithms. In particular, aspects of this disclosure may similarly apply to commercial or consumer electronic devices, such as optical imaging devices, scanners, medical imaging devices, security cameras, or the like. Likewise, embodiments of this disclosure may apply to long-tail filtering, anti-flicker filtering, and glass detection algorithms, or the like.

In embodiments, an algorithm is proposed that serves as a robust mechanism to group and abstract objects based on data obtained from a time-of-flight sensor. This algorithm efficiently aids in the elimination of false targets that may be present within the data collected from a multi-zone time-of-flight ranging device. The implementation of such an algorithm ensures that the sensor data is accurately processed by discriminating against erroneous readings and providing a cleaner, more accurate representation of the environment detected by the time-of-flight sensor.

Conventional algorithms for filtering and processing data from time-of-flight (ToF) ranging devices face several notable drawbacks. A primary concern is the loss of actual weak targets, which may result from the algorithms incorrectly categorizing genuine signals as being caused by blur, glare, flickering, or the long tail effects from laser pulses. The weakness of the target's signal can make it quite similar to the noise generated by these phenomena, leading to its accidental elimination during the cleansing process. Collectively, these improvements enhance ToF device reliability and accuracy, ensuring that they deliver precise range and object detection necessary for their critical applications.

Additionally, some false targets created by blur, veiling-glare, flickering, or long tail still manage to evade detection by these algorithms and are erroneously treated as legitimate targets. These lingering false targets degrade the system's performance by introducing inaccuracies into range measurements. The central problem with these existing algorithms has been their overly simplistic approach. They have often lacked the nuanced capability required to handle the complex nature of these interferences effectively. Thus, they have not only discarded valid but weak signals but also failed to identify all inaccuracies.

In an example case, a ToF ranging device measures the distance of objects on a white desk, including a black keyboard. The keyboard and the desk surface may be at the same distance from the ToF ranging device, the black color of the keyboard absorbs more light than the white desk. Accordingly, the keyboard reflects a weaker signal to the sensor than the white desk surface. In contrast, the response from the white target is strong, resulting in a veiling glare across the field of view. The weak reflection from the black keyboard and the resulting veiling flare from the white background can prevent the traditional sharpening algorithm from distinguishing between a weak signal from the veiling glare of the lens and a weak signal from the real target (i.e., the black keyboard), thus impairing object recognition and ranging accuracy.

Embodiments of this disclosure classify (i.e., groups) the different objects (i.e., here, the black keyboard and the white desk) as separate objects. By doing so, the weak signals from the different objects can be treated differently and the effects of veiling glare can be removed from the data readout.

A mitigation technique for veiling glare includes algorithms that identify and subtract the veiling-glare contribution from the measured signal. For example, sharpening algorithms aim to clarify the actual edges of objects in the FoV by enhancing sharpness and contrast along these boundaries.

In embodiments, enhancements to existing or new algorithms are proposed in sharpening, long-tail filtering, anti-flicker filtering, and glass detection algorithms. The sharpening algorithm counteracts the effects of blur by enhancing edges and improving object definition in the sensor data. The long-tail filtering algorithm addresses the issue of prolonged signal decay from, for example, the VCSEL pulse and aberrant SPAD responses, effectively truncating or reshaping the long tail to reflect actual target distances more accurately. The anti-flicker filtering stabilizes fluctuating signals due to flickering, normalizing readings over time to distinguish between false targets caused by near-limit detection issues and real object data. And, glass detection algorithms recognize and compensate for signals distorted by transparent or reflective surfaces, which could otherwise create ghost images or other false targets within the sensor's range.

Sharpening algorithms have evolved to enhance the quality of data from a ToF sensor. Initially, basic sharpening techniques relied on a simple threshold to clarify the readout. These early methods were foundational but limited in their sophistication and ability to address complex imaging issues that could arise from sensor data.

As technology progressed, new approaches to sharpening were developed, which integrated range and signal-based sharpening techniques. This marked an advance in the processing of ToF sensor data by considering the distance information and the signal strength, thereby enabling a more nuanced enhancement of the sensor's readout. These algorithms not only focused on improving sharpness but also on removing spurious targets that could be caused by lens blur—a common imperfection in imaging that can lead to unfocused images—and other artifacts.

Subsequent iterations saw further improvements by incorporating a simplified model to counteract veiling-glare. Veiling-glare typically results from stray light within the camera system, reducing contrast and removing image details. Addressing this issue allowed for a clearer distinction of actual targets from artifacts caused by lens imperfections and improved the overall fidelity of ToF sensor readouts.

Generally, lens sharpness plays an important role in the sharpening algorithm as it directly impacts the clarity of raw sensor data; better initial image quality leads to more effective sharpening. Further, module veiling glare can severely degrade image quality; thus, an algorithm capable of effectively countering its effects is advantageous. Moreover, a pulse segmenter's ability to discriminate targets within regions of interest allows it to sharply define objects in the field of view and meet the specifications for spatial object discrimination.

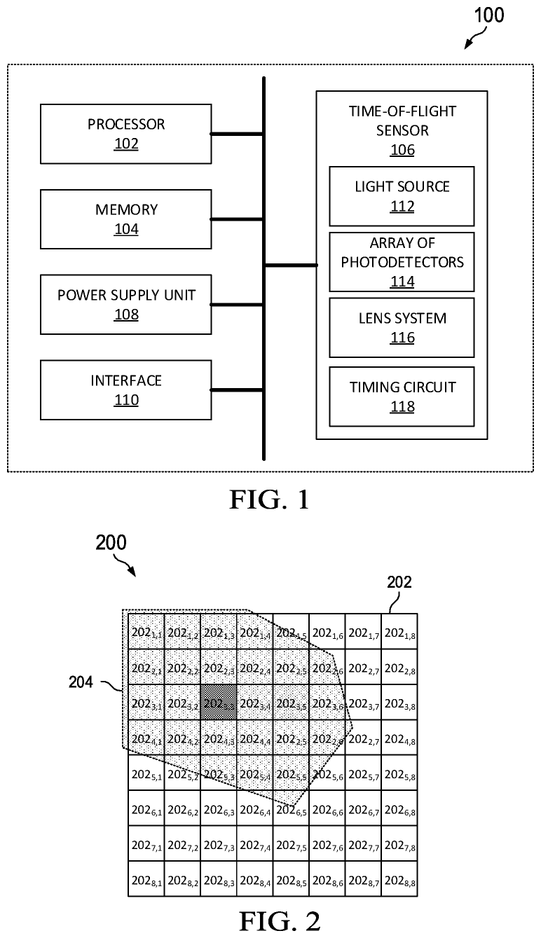

FIG. 1 illustrates a block diagram of an embodiment system 100. System 100 includes a processor 102, a memory 104, a time-of-flight (ToF) sensor 106, a power supply unit (PSU) 108, and an interface 110, which may (or may not) be arranged as shown. Although one of each (i.e., the processor 102, the memory 104, the ToF sensor 106, the power supply unit 108, and the interface 110) is shown in FIG. 1, the number of components is not limiting, and greater numbers are similarly contemplated in other embodiments. System 100 may include additional components not depicted, such as long-term storage (e.g., non-volatile memory, etc.), power management circuitry, security and encryption modules (e.g., trusted platform modules (TPM), etc.), or the like. System 100 may be an electronic device, such as a smartphone, a tablet, a laptop, a smartwatch, a vehicle, or any system or sub-system capable of hosting the ToF sensor 106.

In embodiments, each component can communicate with any other component internally within or external to the system 100. For example, each component can communicate using the I2C (Inter-Integrated Circuit), alternatively known as I2C or IIC, communication protocol, the I3C (Improved Inter Integrated Circuit) communication protocol, the serial peripheral interface (SPI) specification, or the like.

Processor 102 may be any component or collection of components adapted to perform computations or other processing-related tasks. In embodiments, processor 102 is an application processor, a baseband processor, or a microcontroller.

Memory 104 may be any component or collection of components adapted to store programming or instructions for execution by processor 102. In an embodiment, memory 104 includes a non-transitory computer-readable medium.

ToF sensor 106 measures the distance between it and objects in its field of view by utilizing the speed of light. ToF sensor 106 emits a light signal, which travels to the target object, reflects off it, and then is captured back by the ToF sensor 106. The time taken for this round trip is measured—and because the speed of light is constant, the distance to the object can be calculated accurately by the ToF sensor 106 using this time measurement.

ToF sensor 106 includes a light source 112, typically an infrared (IR) LED, a laser diode, or a vertical-cavity surface-emitting laser (VCSEL). The light source 112 emits a light signal towards an object to be measured. In embodiments, ToF sensor 106 uses a continuous wave of light (i.e., indirect time-of-flight (iToF)). In embodiments, ToF sensor 106 uses pulsed light signals (i.e., direct time-of-flight (dToF) applications).

On the receiving end of the signal, there is an array of photodetectors 114 sensitive to the specific wavelength of the emitted light. ToF sensor 106 may include a lens system 116 to focus the emitted light into a beam and to ensure that reflected light is directed onto the array of photodetectors 114. In embodiments, the array of photodetectors 114 is a Single Photon Avalanche Diode (SPAD) detection array. ToF sensor 106 may include additional components not shown, such as memory, a microcontroller, and a VCSEL driver.

ToF sensor 106 may include a timing circuit 118, responsible for accurately measuring the interval between when the light is emitted and when it is detected after reflection. In embodiments, processor 102 receives data from the ToF sensor 106, interprets the timing data, and converts it into distance measurements. The processor 102 may apply algorithms to refine the data, compensating for factors like ambient light noise or object reflectivity variations to provide more reliable distance information. ToF sensor 106 may be a multi-zone ToF sensor that can measure distances in several separate zones, such as 4×4, 8×8, or 16×16 zones.

Power supply unit 108 may be any component or collection of components that provide power to one or more components within the system 100. Power supply unit 108 may include various power management circuitry, charge storage components (i.e., battery), and the like.

Interface 110 may be any component or collection of components that allow processor 102 to communicate with other devices/components or a user. For example, interface 110 may be adapted to allow a user or ToF sensor 106 to interact/communicate with the system 100.

FIG. 2 illustrates an example of a depth map 200 from a multi-zone ToF sensor, such as ToF sensor 106. Depth map 200 includes 64 cells 202_{i,j} arranged in an 8×8 grid, where i=1 to 8 and j=1 to 8. Each cell (also referred to as grid element, pixel, or zone) is identifiable by a subscript denoting the X and Y coordinates in depth map 200. For clarity, when discussing a cell in the depth map 200 generally, it is denoted by cell 202. For example, the cell 202_{1,1} refers to the cell 202 that is at the top left corner of depth map 200 and cell 202_{8,8} refers to cell 202 that is at the bottom right corner of depth map 200.

It should be appreciated that in embodiments, depth map 200 may include fewer or greater number of cells (e.g., 16 cells in a 4×4 grid). Thus, the number of cells 202 in the depth map 200 is non-limiting, and other arrangements are similarly contemplated in other embodiments.

Range profiling using the ToF sensor 106 involves measuring the distance to objects in different areas of the sensor's field of view by detecting the time it takes for light to be emitted from the ToF sensor 106, reflect off the object, and return to the photodetectors in the array of photodetectors 114. The principle behind ToF range profiling is the relationship between the time of flight of light and the distance it travels, with the distance being calculated by multiplying the time taken by the speed of light.

A multi-zone ToF sensor is designed to gather depth information from multiple specific regions within its viewing field (often simultaneously). In embodiments, the light source 112 is an array of emitter elements that project light onto a scene, and a corresponding array of photodetectors 114 captures the reflected light. In embodiments, each photodetector corresponds to a different zone or region in the scene. By controlling the illumination and readout of each zone, as well as by employing timing electronics, the ToF sensor 106 can construct a detailed depth map that represents distances for each zone.

Each cell 202 within the depth map 200 corresponds to a specific photodetector within the array of photodetectors 114. Essentially, the depth map 200 is a pixelated representation of the scene, where each cell 202 represents a volumetric portion of the sensor's field of view. Each cell 202 encodes the distance from the ToF sensor 106 to the object's surface in that particular direction.

When the light source 112 illuminates the scene, the light reflects off objects and returns to the corresponding photodetectors in the array of photodetectors 114. The time it takes for this light to return is recorded for each photodetector. These time measurements are then converted into distance values using the known speed of light. Thus, in the depth map 200, each cell 202 contains a value reflecting the measured distance for its specific area in space, which translates into how far or close objects are relative to the sensor in that zone.

The spatial resolution of the depth map 200 (i.e., how finely it can represent surface details) is determined by the number and density of the cells 202 in the map, corresponding to the number of photodetectors in the array of photodetectors 114. A higher density of smaller grids will yield a finer resolution depth map, capturing more detailed information about the scene's geometry. Conversely, a lower density with larger grid elements will produce a coarser representation, which suffices for detecting larger objects or applications requiring less spatial precision. The sensor's ability to capture multiple zones rapidly or simultaneously allows for real-time range profiling, vital in dynamic environments or applications such as robotic navigation, gesture recognition, and 3D modeling.

The visual representation of the depth map can resemble a grayscale image where the intensity of each cell 202 corresponds to distance values—darker cells 202 represent closer distances, and lighter cells 202 represent further distances, or vice versa, depending on the chosen convention. Some depth maps may also be color-coded to enhance visual contrast and understanding of depth information.

In a numerical representation of a depth map, each cell 202_{i,j} in the depth map 200 includes a value representing the distance from the ToF sensor 106 to the object or surface at that specific point in the field of view. These numbers effectively replace the grayscale or color gradients typically used in visual depth maps.

Each cell 202_{i,j} can contain a number that indicates how far away an object is from the ToF sensor 106, with, for example, smaller numbers indicating closer proximity and larger numbers signifying greater distances. This numerical approach allows for a precise distance quantification for each point on cell 202, making it particularly useful for applications where numerical data are preferred over visual representation, such as in automated navigation systems or robotic control algorithms where distances need to be processed algorithmically rather than visually.

The outline of object 204 within the scene appears on the depth map 200 as a collection of cells 202, which are differentiated from the background by representing closer distances. The numbers corresponding to object 204 would thus be smaller than those of the background, revealing the object's location and form. For example, a cell with a value of ‘312’ indicates that object 204 is 312 units (e.g., millimeters) from the sensor at that point, while a cell with a value of ‘326’ would be 326 units away. As shown, cell 202_{3,3} with, for example, a value ‘312’ is the closest cell 202 to object 204.

The edges or contours of object 204 on this grid are identified by observing the transition between numeric values where there's an abrupt change from smaller (closer) to larger (further) numbers. Such transitions demarcate the boundary or silhouette of object 204 against other objects or regions in the depth map 200. By scanning across the grid, one can trace out these contours and understand the shape of object 204 shape and spatial orientation relative to other elements in the scene.

In certain embodiments, each cell 202 may have multiple range values, for instance, it may include a foreground range and a background range. This configuration may be relevant when veiling glare originating from the foreground object 204 produces a uniform range value throughout the entire FoV. Consequently, the background ranges outside the area covered by object 204 are only perceptible as a secondary range lying beyond the initial range caused by the veiling glare.

Each cell 202 not only helps in outlining object 204 but also provides data critical for understanding its three-dimensional structure. This information can be used to construct a 3D model of object 204 or to determine how its position and size relate to the ToF sensor 106 and other objects.

This artifact of the veiling glare makes it difficult for a time-of-flight system to differentiate between direct signals from actual targets and the scattered light from the veiling glare, which impacts both covered and uncovered areas of the FoV. As a result, without proper mitigation, a time-of-flight system may behave as if it is “single-zone” despite being a multi-zone sensor capable of detecting different ranges because it reads the veiling-glare-influenced range everywhere.

The cells 202 that are neighboring the edges or contours of object 204 may present a deceptive appearance of an object because of, for example, the lens flare or the long-tail effect from the VCSEL. Traditionally, a specified threshold has been applied to the readings for cell 202 to detect and eliminate the effects of the veiling glare.

In scenarios with complex scenes, different target objects with varying distances and reflectivity can challenge the ability of the system 100 to distinguish and accurately measure ranges. With a ToF sensor susceptible to even small signals, veiling-glare becomes a significant issue. Veiling-glare is stray light that scatters within the device's optics and creates unwanted light contributions across the array of photodetectors 114.

In an example case, a knife-edge target covers half of the field of view (FoV) of the ToF sensor 106 and a background target is further away. The knife-edge target is directly between the ToF sensor 106 and the background target, obscuring part of the background. Since this stray light can come from the brighter parts of the scene (in this case, potentially from the knife-edge or background targets), it can generate false range readings (e.g., blurring at the edge of the target and veiling glare at the background) across all zones of the array of photodetectors 114.

Embodiments of this disclosure provide deconvolution techniques and algorithms aimed to mathematically reverse the effects of image blur. Grouping algorithms are proposed to more accurately segment pulse data into regions of interest. The algorithms further refine the clarification process and enhance the detection of spatial objects. The advancements allow the removal of erroneous targets in the ToF sensor data that may be caused by issues such as lens blur and veiling glare, which can detract from the reliability of the sensor's output and complicate subsequent tasks such as object recognition and scene analysis.

Once the grouping algorithm classifies different objects to different groups, a unique thresholding is applied to each group. For example, the foreground target, characterized by a robust signal, undergoes a thresholding process where any elements within its range grouping that exhibit a weak signal, or what is identified as veiling glare, are eliminated. This ensures that only the truest representation of the foreground target is maintained. The same thresholding principle can be applied to the background target. Despite the weaker signal of the background compared to the foreground, the background target also produces a veiling glare, albeit even weaker than the foreground target. The veiling glare can be expunged from the background target by utilizing the thresholding technique.

Conventional algorithms for grouping objects deploy a relatively straightforward approach-sorting targets by ascending range. Initially targeting the closest range within a first zone, then proceeding to the next closest, and so forth. A threshold is employed at intervals between each sorted range within the zones. If the range closely matches the preceding range in sequence, connectivity is inferred and categorized with the same object. Conversely, a significant gap between two sorted ranges suggests the presence of distinct objects, potentially indicative of a background object.

However, this conventional approach has limitations due to its lack of spatial awareness. For example, two isolated zones on opposite ends of the array (e.g., both at 100 millimeters) can be erroneously grouped as part of the same object due to an identical range, despite the substantial spatial gap separating them. In this case, if the two objects have disparate reflectance properties (e.g., the black keyboard on the white surface), if these items are incorrectly grouped or treated as a single object, the thresholding system that is designed to remove veiling glare might erroneously perceive the less reflective item (the darker object) as part of the veiling glare. This occurs because the system fails to recognize it as an independent object, resulting in an inaccurate representation of the objects being imaged. Thus, although the simple algorithm has been functional for initial, less complex applications, its imperfections are clear in scenarios requiring more precise spatial differentiation.

In embodiments, the algorithm is enhanced with spatial awareness capabilities (i.e., object abstraction features). Initially, the goal is to accurately group actual objects in temporal and spatial dimensions. Temporal grouping involves considering the object's range or time for a light pulse to travel to the object and back. Spatial grouping links corresponding ranges across each zone of an array, arranging them side by side or vertically. This allows the algorithm to discern whether what might appear to be a single object due to similar range readings as separate objects if they are physically discrete. By doing so, the system avoids inappropriately combining multiple objects into a single entity.

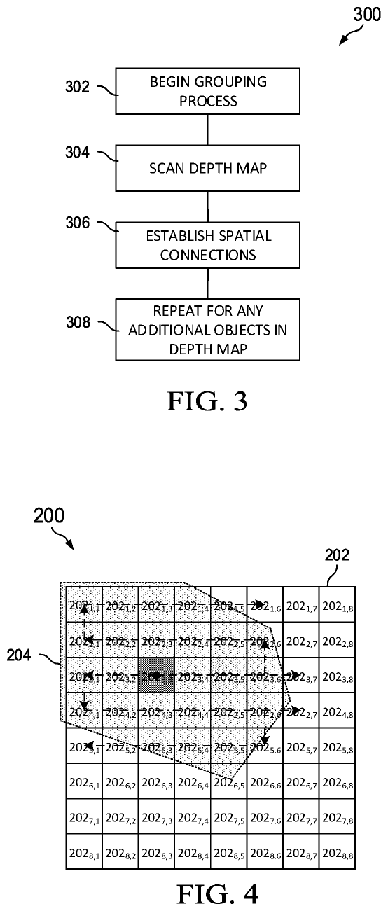

FIG. 3 illustrates a flow chart of an embodiment method 300 for grouping objects (i.e., object abstraction) using a depth map 200 from the ToF sensor 106. FIG. 4 illustrates an implementation of method 300 on the depth map 200. Method 300 may be executed by, for example, processor 102 using instructions stored in memory 104. Method 300 is explained with the assistance of FIG. 4. It is noted that all steps outlined in the flow chart of method 300 are not necessarily required and can be optional. Further, changes to the arrangement of the steps, removal of one or more steps and path connections, and addition of steps and path connections are similarly contemplated.

Method 300 allows simultaneous consideration of temporal and spatial factors to distinguish and cluster objects as indicated on a depth map from a ToF sensor. This dual-axis analysis significantly enhances the algorithm's differentiation capabilities compared to conventional techniques, especially when encountering objects proximately located within the same range from ToF sensor 106. Advantageously, method 300 makes it possible to identify and separate two objects that exhibit a discernable gap in range measurements while in close range proximity, effectively allowing for a clear distinction. Subsequent algorithms can then process these individually clustered objects individually, improving the accuracy and effectiveness of the system 100.

In embodiments, method 300 employs an object abstraction technique to distinguish between different objects by conducting a raster or a spiral search pattern by, for example, alternating between sweeping left to right and then up and down systematically. During this scanning process, the edges of an object are detected, which guides the continuation of the search. Upon locating an object, the method allows for determining various high-level parameters related to the object. These include, for example, calculating its centroid, determining its size in X and Y dimensions, establishing the minimum, maximum, and median ranges, and assessing its reflectance by analyzing the returned signal based on its range. This comprehensive set of parameters can yield a detailed understanding of the object's characteristics.

At step 302, the grouping process commences by pinpointing the nearest target. This initiation requires selecting the cell with the smallest depth value recorded in the depth map 200, with the additional condition that it was not previously incorporated into any group. This ensures a systematic and non-redundant coverage of all targets within the map. In FIG. 4, cell 202_{3,3} is the closest cell 202 to object 204. Accordingly, the grouping process starts at the starting cell 202_{3,3}.

At step 304, the search continues from the starting cell (e.g., 202_{3,3}) by scanning horizontally and vertically across the depth map 200. Specifically, the scan progresses cell by cell, checking for a spatial connection to the previously examined cell 202. This dual-direction scanning focuses on identifying and linking neighboring areas that indicate continuous parts of an object. When a cell is determined to have a range different from the previously examined cell by a specific threshold, the scan progresses vertically by one cell based on a predetermined search algorithm. Then it moves in the opposite horizontal direction from the previous row. The search sequence continues until all scanned edge cells are determined to exceed the specified threshold.

In embodiments, once the initial starting point has been identified at step 302, a spiral scanning process commences across depth map 200. This involves advancing from one cell 202 to the next in a spiral pattern, ensuring each cell 202 has a spatial connection to previously examined cells.

In embodiments, the spiral scanning process involves a circumferential movement aimed at detecting and connecting adjacent segments that represent contiguous parts of an object. A cell 202 is considered part of the spiral pattern if its range is within a pre-defined threshold compared to the range values of its immediate inner neighboring cells. When this condition is met, the scanning proceeds to encompass an additional cell in the spiral, expanding either outward or circularly following an established search algorithm. This expansion imitates forming concentric “rings,” producing a pattern that echoes FIGS. 9a to 9c and advancing systematically in either a clockwise or counter-clockwise direction. This spiral search sequence is maintained until it is observed that all the peripheral cells being scanned surpass the pre-set range threshold.

For example, in FIG. 4, the horizontal scan begins from the starting cell 202_{3,3} to cell 202_{3,1} in the left direction and from the starting cell 202_{3,3} to cell 202_{3,7} in the right direction. In the left direction at cell 202_{3,1}, the search continues downward to cell 202_{4,1} and then to the right direction until cell 202_{2,7}. As cell 202_{2,7} has a range value below the specified threshold, the search reverts to cell 202_{2,6}. Then it moves downward to cell 202_{5,6} and then to the left direction until cell 202_{5,1}, at which point the first scan direction ends because the range values for all adjacent cells not scanned to the previous cell exceed the specified threshold.

In the right direction, as cell 202_{3,7} has a range value below the specified threshold, the search reverts to the previous cell 202_{3,6} and then moves upward to cell 202_{2,6} and then to the left direction until cell 202_{2,1}. The search continues upward to cell 202_{1,1} and then in the left direction until cell 202_{1,6}, at which point the second scan direction ends because the range values for all adjacent cells not scanned to the previous cell exceed the specified threshold.

During the initial search phase, the system 100 is tasked with locating spatially-connected targets. These targets are identified by their interconnectedness in terms of the depth information they present and their coordinates in the plane of the depth map 200. To ensure comprehensive target identification, the search encompasses multiple attributes, including ranges, sensor signals, and reflectance values.

In embodiments, object parameters are determined, which add detailed characteristics to each identified object. Among the parameters that can be ascertained are the centroid coordinates (x, y), determined potentially via the barycenter method, and size measurements along the x and y axes. Moreover, the system computes statistical figures for both range and rate: minimum, maximum, and median values alongside standard deviations (sigma). Depth information is derived by analyzing the variance within the grouped range data, and reflectance details capture the extent of light reflected off object surfaces, classified between minimum and maximum values or measured as median reflectance. Additionally, the rate and its variance are tabulated similarly. In embodiments, the analysis extends to categorizing surface characteristics on a sliding scale from Lambertian to specular reflection; this could necessitate a separate search commencing with regions exhibiting the highest rates.

Step 306 establishes spatial connections between adjacent zones by applying threshold-based criteria. Based on depth values and other relevant parameters, these criteria determine whether contiguous cells share sufficient commonality to be considered part of the same object. The thresholds identify zones within the same grouping, differentiating between distinct objects.

In embodiments, the thresholding approach intends not only to implement current schemes but may also involve additional refinements for enhanced discrimination between connected and separate objects. These refinements may lead to more precise groupings based on an improved understanding of object continuity within the three-dimensional space depicted by the depth map.

Accordingly, following the identification and characterization of objects, they are then subject to ranking. This ranking system or assignment of a significance factor can be predicated upon several properties, such as size and rate. Such rankings enable prioritization or further analysis of the objects based on their perceived importance or relevance to the application.

At step 308, the previous steps are replicated for additional objects within the depth map. Each cycle targets the next closest object that remains ungrouped after prior iterations. This continues until the entire map has been searched, with each target being assessed and, if applicable, integrated into a grouping along with adjacent targets that meet the established thresholds. This could include objects situated in the background. Repeating method 300, a comprehensive visual representation is constructed from the depth map 200, encompassing all detectable objects within the field of view.

Thus, method 300 initiates from the nearest detected target, which, although typically at the center of the field of view, is not necessarily at the object's center. The search then progresses simultaneously in both lateral directions-rightward and leftward from this starting point. As the search expands outward, if it encounters a zone where the range measurement significantly differs from the adjacent one, it concludes that this new range likely does not belong to the same object. At that point, the algorithm halts its lateral movement in that direction and redirects its focus to scanning vertically-upward or downward. This process continues until the entirety of the object's dimensions are mapped. Once the search algorithm reaches zones that no longer correlate with the established range, indicating they lie outside the defined object, it terminates the search in those directions.

In embodiments, when the search comes across zones or cells 202 that it has determined to no longer belong to the same object based on, for example, the value of cell 202 falling outside a specified threshold value, it does not immediately conclude the search for that object. Instead, the search can extend to the adjacent row or column-either above, below, to the right, or the left-continuing its search to detect any parts that may still be connected to the main body of the object. This approach can help identify objects with protruding features in a single direction, such as objects with multiple horn-like extensions. Accordingly, the proposed search ensures comprehensive coverage and accounts for the full expanse of the object's distinctive characteristics.

For example, method 300 can identify that object 204 is a cup, measuring 5 centimeters in width and 10 centimeters in height. The process can also locate the center of the cup, providing a high-level descriptive analysis of the object. Following this initial identification, method 300 analyzes data from other zones within the depth map 200 to confirm the accuracy of the information obtained and ascertain whether these additional zones represent valid data or false positives.

The conventional sorting algorithm, when analyzing depth map 200, if, in addition to object 204, a measurement of, say, 320 units is determined at the bottom right corner, might mistakenly categorize object 204 and the object at the bottom right corner together due to their similar range values. This indicates an imperfection in the system, as it fails to distinguish between separate objects with similar range values. This can be particularly problematic for the two objects with different reflectance and a different signal for the same range.

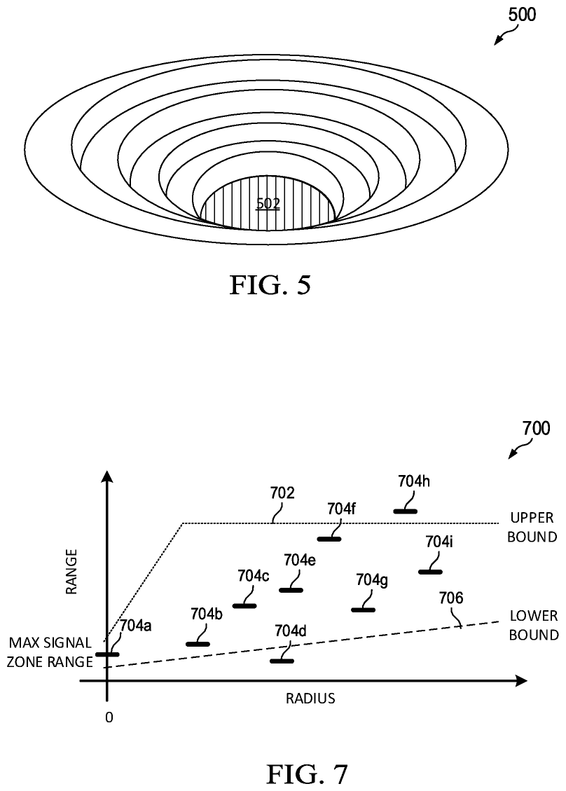

FIG. 5 illustrates an example of a bowl 500 from veiling glare, represented as concentric range circles. The typical response patterns obtained from veiling glare often resemble a bowl shape, as depicted. This kind of veiling glare may emanate from a target occupying a few central zones within the field of view, where the legitimate target yields a response within the range 502—denoted as hashed region within the bowl 500 (i.e., the legitimate response range). The range of the veiling glare tends to expand with increasing distance from the target, leading to a bowl-shaped effect, as illustrated in FIG. 5.

In embodiments, the algorithm detects veiling glare based on its characteristic shape within the range data. The algorithm can be programmed to search for this specific contour, allowing it to identify regions likely affected by veiling glare. Since few naturally occurring objects mimic this bowl-like shape, its detection serves as an effective metric to distinguish veiling glare from valid targets in the observed environment. This tool ensures that such glare is recognized and accounted for properly in the imaging process.

Multiple indicators can identify an object as having a bowl shape, such as searching for rings and concentric circles. For example, when outlining a bowl's surface, these outlines or ‘rings’ will serve as contours for analysis. To determine if something has a bowl-like form, two key attributes can be evaluated: the flatness of each contour and the degree of curvature. By examining the flatness, we can discern how each concentric ring lies in space, while the curvature assessment helps one understand how much each ring arcs, thus contributing to the overall determination of a bowl-shaped pattern.

In light of this bowl-shaped effect, either a spiral search strategy or a pseudo-peripheral search strategy can be implemented to detect the presence of veiling glare. In embodiments, the pseudo-peripheral search commences at the range nearest to the observer and progresses outward in a spiraling trajectory. Alternatively, an approach can be taken to incrementally pan through successive concentric circles, examining each circular band in turn to ascertain the existence of the aforementioned bowl shape. In embodiments, the search begins from the cell that exhibits the greatest signal or intensity, such as in cases where a spot is created due to a reflection off a glass or shiny surface.

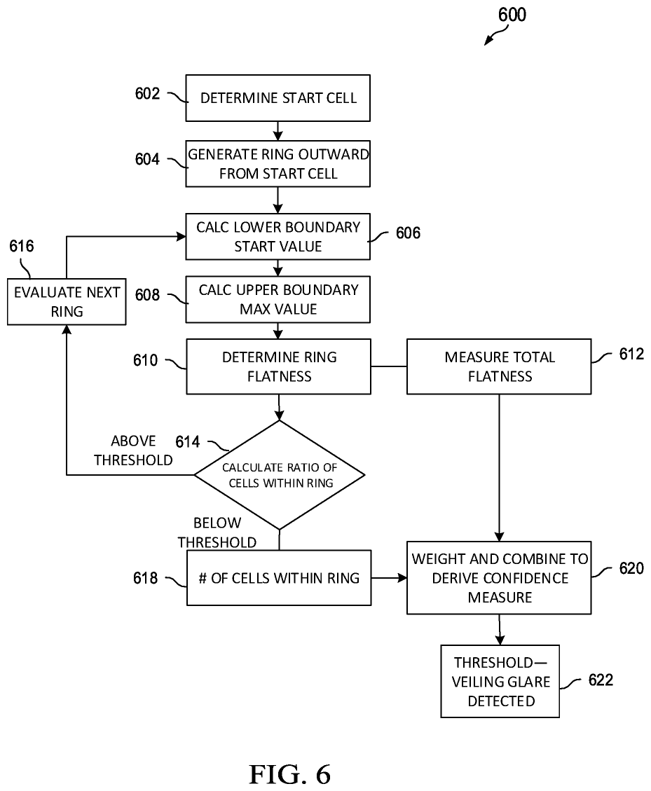

FIG. 6 illustrates a flow chart of an embodiment method 600 for a pseudo-circumferential search and flatness measurement to detect veiling glare in depth map 200 from the ToF sensor 106. FIG. 7 illustrates a plot 700 of an embodiment range profiling to detect veiling glare. Method 600 may be executed by, for example, processor 102 using instructions stored in memory 104. Method 600 is explained with the assistance of FIGS. 2 and 7. It is noted that not all steps outlined in the flow chart of method 600 are required and can be optional. Further, changes to the arrangement of the steps, removal of one or more steps and path connections, and addition of steps and path connections are similarly contemplated.

In embodiments where the array of photodetectors 114 possesses a low resolution, rectangles can be used as a suitable substitute for circles for a depth map to represent circular shapes accurately.

At step 602, pseudo-circumferential search and flatness measurement begins by determining the starting cell corresponding to the genuine target's center. In embodiments, the genuine target center is the cell in depth map 200 having the maximum signal (i.e., max-signal-zone). In embodiments, the center of the genuine target is the closest cell to the object. In embodiments, the center of the genuine target is the cell that generates the max signal from the object due to, for example, the surface reflectance of the object and not necessarily the closest cell to the object. For example, in the depth map 200, the starting cell 202_{3,3} has the maximum signal value. In an embodiment, the center of the genuine target is determined by the object search, as determined by object search and barycenter method using, for example, method 300.

At step 604, the first rectangular ring to be evaluated is determined by moving outward by one cell in all directions (i.e., working out from the cell with the max-signal-zone) from the starting cell. Subsequent rings to be evaluated are determined by extending the size of the ring by moving outward by one cell from the previous ring.

At step 606, a lower boundary 706 is calculated for the ring under evaluation. The lower boundary 706 is set to trace the average inner limit of cell 202 with the condition that it consistently remains non-decreasing. The plotting begins at an initial point at zero radius (o).

In embodiments, the lower boundary 706 is set based on the range of the genuine target's center because no other cell in the object should have a signal value below the max signal zone (i.e., a cell that has a signal below the max-signal-zone value of the genuine target would imply that the other cell is the center, which is not possible). Accordingly, by setting the lower boundary 706 to track the range of the genuine target's center, any cell profile that falls below the lower boundary 706 would be outside the bowl shape (e.g., zone 704d).

In embodiments, the lower boundary 706 is set to the maximum of two evaluated criteria. The first criterion is a previous inner lower boundary or, when the radius equals ‘1’, the spot range). The second criterion is the mean range of the border of a certain radius with a margin applied (e.g., a margin of ‘0.8’) to allow for noise.

At step 608, an upper boundary 702 is calculated for the ring under evaluation. The upper boundary 702 is set to trace the average of the outermost limit of cell 202 but is designed not to surpass a predefined merging distance (i.e., where two pulses overlap). The upper boundary 702 is set based on the predefined merging distance because one is guaranteed to have a different target outside this range value (e.g., zone 704h). In embodiments, the predefined merging distance is set by the physical properties of the pulse width.

In embodiments, the upper boundary 702 is set to the minimum of two evaluated criteria. The first criterion is the merging distance (i.e., the distance below which merging can happen). The second criterion is the mean range of the n^{th} percentile (e.g., 25^{th} percentile) of cells in the border of a certain radius from the genuine target's center (e.g., starting cell 202_{3,3}) with an applied margin (e.g., a radius of ‘3’ with a margin of ‘1.5’) to allow for noise.

In embodiments, the calculation of the lower boundary 706 and the upper boundary 708 in steps 606 and 608 are automatically generated to describe the shape of the bowl.

At step 610, the ring under evaluation is analyzed for its flatness-given that data corresponding to the veiling glare is flat. The “flatness” of the ring, as defined here, is more a measure of the ring's roughness (or smoothness) as well as any slant. In one embodiment, it is defined as the square root of the sum of the squares of the “errors” of the cells within the ring. The “error” is the normalized difference between the mean of the ring.

For the ring under evaluation, the analysis includes calculating a measurement that quantifies the proximity of ranges for the ring under evaluation to the mean of the ranges for the same ring in the depth map. This step is critical for assessing the consistency of the data. It is important to note that this process does not require the execution of a curve-fitting procedure because, under the presumption of veiling-glare influence, the expected gradient value is zero. Therefore, attempting to apply a fit to model this effect is unnecessary.

To further evaluate the accuracy of this presumption, one assesses how closely the actual data ranges align with a theoretical veiling-glare “fit.” This is achieved by calculating the R-squared value of the “fit,” which, although typically indicative of a fitting process, in this case, serves as an indicator of conformity of the data ranges to an expected zero-gradient condition implied by veiling-glare effects. An R-squared value close to zero would suggest that the ranges are much more consistent with a veiling-glare scenario showing little to no gradient and a smooth surface, thus validating the initial assumption.

For each ring under evaluation, the mean range value (r̅a̅n̅g̅e̅_̅{̅b̅}̅) and normalized error value (error_{z}) of cells within the ring under evaluation is calculated to provide a figure of flatness for the border region.

The mean range value (r̅a̅n̅g̅e̅_̅{̅b̅}̅) can be calculated using, for example, the equation:

$$\overline{{range}_{b}} = \frac{1}{m} {\sum }_{z ∈ B}^{m} {range}_{z} ,$$

where b is the border region (i.e., ring) under evaluation, B is the set of border cells, z is the cell, and m is the number of cells within the border region.

The normalized error value (error_{z}) can be calculated using, for example, the equation:

$${error}_{z} = \frac{{range}_{z} - \overline{{range}_{b}}}{\overline{{range}_{b}}} ,$$

where z is the cell as a member of the set of border cells (B).

At step 612, the total flatness of the object (f) is determined using the propagation of uncertainty, f=\sqrt{Σ_{z∈V}ⁿrsq_{z}}, where n is the total number of valid cells in the depth map 200. For all valid cells, a root squared value (rsq_{z}) is calculated. The root squared value (rsq_{z}) can be calculated using, for example, the equation: rsq_{z}=error_{z}², z∈V, where Vis the set of all valid cells within the merging distance. “Valid” cells are normally any valid range within the field-of-view (some ranges will have already been deemed invalid by other algorithms). But equally, “valid” cells could also be defined as those already identified as objects by the previous methods outlined above.

Accordingly, the R-squared values derived from each border region are aggregated. If each cell within those regions returns a high R-squared measure, the surface is not level (i.e., not flat) within the border region under analysis. Consequently, the cumulative flatness measurement value will be high. Conversely, if the R-squared values are low, suggesting minimal deviation from the ideal zero-gradient or perfect flatness, the summed total of these values across all cells will also be low. Therefore, the algorithm uses this cumulative score to indicate flatness: a low flatness measurement value denotes a smooth, even surface. In contrast, a high value signals an uneven or non-flat surface.

Step 614 analyzes the ring under evaluation based on the pseudo-circumferential search. the number of cells 202 within the border region that indicate an object or a veiling glare determined. The ratio of cells within the border region that indicate an object or veiling glare to the total number of cells in the border is calculated. If the ratio is above a set threshold, the process is repeated for the next ring at step 616. In contrast, if the ratio falls below the set threshold, the method turns to step 618.

The profiling of the cells within each range is shown in plot format in FIG. 7. Each cell 202 surrounding the starting cell 202_{3,3} includes a value (range versus radial distance from the center) 704b-i. The radial distance for each cell to the genuine target's center is plotted on the X-axis and its range value is plotted on the Y-axis of FIG. 7.

As shown in FIG. 7, the radius profile for each cell 202 from the center of the genuine target (e.g., starting cell 202_{3,3}) is established in terms of cell or zone widths. For every radius, an upper boundary 702 and a lower boundary 706 are determined, commencing with the range where the signal is at its maximum (max-signal-zone) for the starting cell 202_{3,3}.

During each ring evaluation, progressing outward from the center of the genuine target, the location of each cell 202 is plotted based on its radius from the genuine target's center, as shown in an exemplary embodiment in FIG. 7. This allows for assessing whether the cell conforms to a profile resembling a bowl shape. Establishing these upper and lower boundaries creates a filtering effect, which delineates the expected contour of the circles. The step-by-step plotting across radii aids in visualizing and defining what the expected bowl-shaped profile would look like based on the data from each cell 202.

For example, the horizontal and vertical distances for cell 202_{1,5} from the starting cell 202_{3,3} on the depth map 200 are, respectively, two and two. To calculate the radial distance (d) for cell 202_{1,5} using the Pythagorean theorem, you take the square root of the sum of the squares of the horizontal and vertical distances. In this example, the radial distance for cell 202_{1,5} from the starting cell 202_{3,3} is d=\sqrt{2²+2²}=\sqrt{8}≈2.82. As another example, the radial distance for cell 202_{3,4} from the starting cell 202_{3,3} on the depth map 200 is one (‘1’) because the vertical value is zero and the horizontal value is 1. The radial distance for each cell in the object identified from method 300 is repeated and plotted similarly to that shown in FIG. 7.

Accordingly, to effectively detect and exploit the bowl-shaped veiling-glare signature, method 600 employs a radial search mechanism. This resembles the technology used in glass detection and involves a search for specific geometrical patterns, such as concentric rings. Additionally, method 600 can assess the flatness and curvature of the detected rings and the average range across each curvature. This process accurately determines the presence and extent of veiling-glare within the sensor's field of view. Through this analysis, method 600 significantly enhances object detection and grouping capabilities in time-of-flight sensor applications.

Step 618 calculates the total number of the cells in the rings with a ratio above the threshold in the previous steps. The last ring, which had a ratio below the threshold, is not included in the summation.

At step 620, the results from step 618 (i.e., the number of cells within the rings that have a ratio above the threshold) and from step 612 (i.e., the total flatness measurement) are analyzed to derive a confidence measurement value to determine the existence of veiling glare. In embodiments, the confidence measure is derived by weighting, biasing, and clipping each sub-measure (number of cells within the rings, flatness).

At step 622, based on the confidence measurement value, the method can determine the existence of a veiling glare on depth map 200. If the confidence measurement value indicates no veiling glare, then all cells defined using, for example, method 300 are part of an object and not veiling glare. In contrast, If the confidence measurement value indicates a veiling glare, then all cells defined using, for example, method 300 are veiling glare, which can be removed from the depth map (i.e., filtered out). Once identified, the filtering of the veiling-glare can take place on a cell-by-cell basis, using more conventional methods (e.g., thresholding based on the signal level-veiling-glare exhibits low signal).

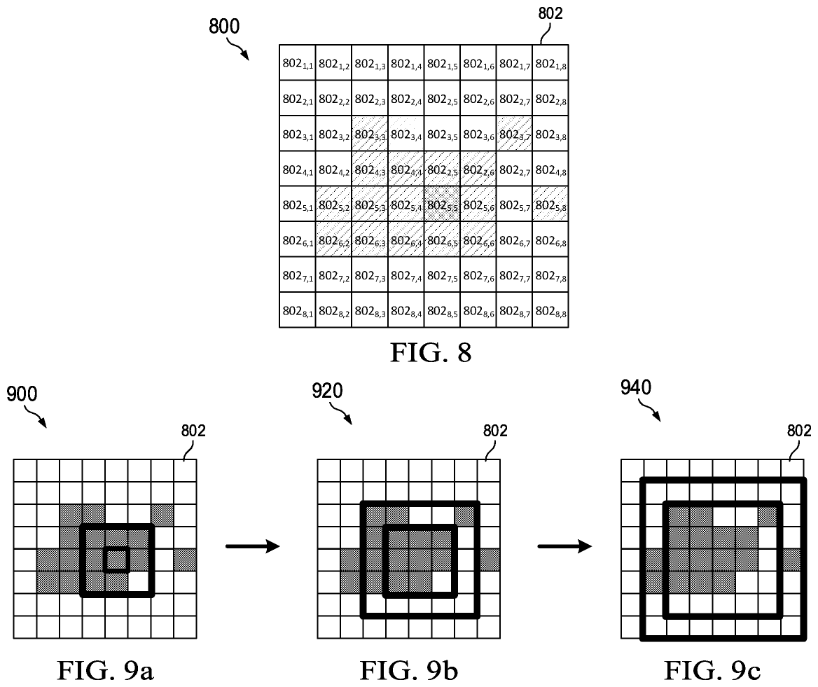

FIG. 8 illustrates an example of a depth map 800 from a multi-zone ToF sensor, such as ToF sensor 106. Depth map 800 includes 64 cells 802_{i,j} arranged in an 8×8 grid, where i=1 to 8 and j=1 to 8. Each cell is identifiable by a subscript denoting the X and Y coordinates in depth map 800. For clarity, when discussing a cell in the depth map 800, it is generally denoted by cell 802. It should be appreciated that in embodiments, depth map 800 may include fewer or greater number of cells (e.g., 16 cells in a 4×4 grid). Thus, the number of cells 802 in the depth map 800 is non-limiting, and other arrangements are similarly contemplated in other embodiments.

In embodiments, depth map 800 corresponds to a veiling glare at 400 millimeters with an 88% background at 1400 millimeters. The shaded cells 802 in depth map 800 indicate a range value below a threshold indicating, for example, an object or veiling glare. In contrast, the unshaded cells 802 in depth map 800 corresponds to the background. In depth map 800, the center of the genuine target is starting cell 802_{5,5}, corresponding to the maximum signal (i.e., max-signal-zone) and not necessarily the cell having a range value that is closest to the object.

Given the depth map 800, FIGS. 9a-c illustrate the progression of a pseudo-circumferential search and flatness measurement based on method 600. The depth map 900, 920, 940 in these figures correspond to the depth map 800 in FIG. 8; however, they are denoted differently based on the progression of the ring under evaluation.

In each of the FIGS. 9a-c, an inner and outer rectangle are drawn, creating a corresponding ring or border region in each figure. For example, the number of cells 802 within the border region is eight ‘8’ in FIG. 9a, the number of cells 802 within the border region is sixteen ‘16’ in FIG. 9b, and the number of cells 802 within the border region is twenty-four ‘24’ in FIG. 9c.

For each FIG. 9a-c, the ratio of cells within the border region that indicate an object or veiling glare to the total number of cells in the border region is calculated. In response to the ratio being greater than a threshold value (e.g., 0.25), the search expands by moving outward from the starting cell by another cell in all directions (i.e., working out from the cell with the max-signal-zone).

For each ring under evaluation, the mean range value (r̅a̅n̅g̅e̅_̅{̅b̅}̅) and normalized error value (error_{z}) of cells within the ring under evaluation is calculated.

In FIG. 9a, the search begins by moving one cell adjacent to the starting cell 802_{5,5} in all directions. Thus, the border region in FIG. 9a includes seven ‘7’ cells surrounding the starting cell 802_{5,5}. The number of cells 802 within the border region that indicate an object or a veiling glare in FIG. 9a is also seven ‘7’ (highlighted cells 802). Accordingly, the ratio of cells within the border region that indicate an object or veiling glare to the total number of cells in the border for FIG. 9a is one ‘1’. As the ratio is above the threshold value of 0.25 (non-limiting), the search continues to FIG. 9b.

Accordingly, in FIG. 9b, the search continues by moving one additional cell outward in all directions from the previous FIG. 9a. Thus, the border region in FIG. 9b includes sixteen ‘16’ cells. The number of cells 802 within the border region that indicate an object or a veiling glare in FIG. 9b is six ‘6’. Accordingly, the ratio of cells within the border region that indicate an object or veiling glare to the total number of cells in the border for FIG. 9b is 6/16 or ‘0.375’. As the ratio remains above the threshold value of 0.25 (non-limiting), the search continues to FIG. 9c.

Thus, in FIG. 9c, the search continues by moving one additional cell outward in all directions from the previous FIG. 9b. Thus, the border region in FIG. 9c includes sixteen ‘24’ cells. The number of cells 802 within the border region that indicate an object or a veiling glare in FIG. 9c is three ‘3’. Accordingly, the ratio of cells within the border region that indicate an object or veiling glare to the total number of cells in the border for FIG. 9c is 3/24 or ‘0.125’. The search ends as the ratio has fallen below the threshold value of 0.25 (non-limiting).

Based on the search results, any cell 802 that falls within the last boundary region, having a ratio below the threshold value (e.g., 0.25), is not connected to the main object and is discarded. Likewise, any cells 802 that fall outward from the last boundary region in depth map 800 are also discarded. Finally, the total flatness of the object (f) is determined using the propagation of uncertainty.

A first aspect relates to a method for object abstraction to distinguish between different objects in a depth map generated from a time-of-flight sensor. The method includes conducting a raster or spiral search on the depth map. The raster search includes alternating between sweeping left to right and then up and down systematically. The spiral search includes a circumferential-direction scanning. The method further includes detecting edges of an object to guide a continuation of the raster or spiral search, calculating one or more high-level parameters related to the object, and repeating the raster or spiral search for cells of the depth map that have not been previously swept to similarly identify other objects.

In a first implementation form of the method according to the first aspect as such, the one or more high-level parameters of the object comprises a center, a size, a minimum range, a median range, a maximum range, a reflectance, or a combination thereof.

In a second implementation form of the method according to the first aspect as such or any preceding implementation form of the first aspect, for each raster or spiral search, the method further includes determining a starting cell within the depth map not previously scanned and with the lowest range value.

In a third implementation form of the method according to the first aspect as such or any preceding implementation form of the first aspect, the raster search includes scanning horizontally and vertically across the depth map starting from the starting cell. The spiral search comprises a circumferential-direction scanning from the starting cell.

In a fourth implementation form of the method according to the first aspect as such or any preceding implementation form of the first aspect, the raster search includes shifting from the horizontal scan to the vertical scan in response to determining that a range value of a cell is above a threshold value and reverting to a previous cell before shifting to the vertical scan. The spiral search includes shifting around a circle or outwards in the shape of a spiral from one cell to the next in response to determining that the range value of a cell is within the threshold value compared to surrounding cells.

In a fifth implementation form of the method according to the first aspect as such or any preceding implementation form of the first aspect, the raster search comprises shifting from the vertical scan to the horizontal scan in response to determining that a range value of a cell is above a threshold value and reverting to a previous cell before shifting to the horizontal scan. The spiral search comprises shifting around a circle or outwards in the shape of a spiral from one cell to the next until all scanned edge cells are determined to exceed a threshold value.

In a sixth implementation form of the method according to the first aspect as such or any preceding implementation form of the first aspect, the method further includes applying different threshold values to remove veiling glare effect for each object identified.

A second aspect relates to a method for pseudo-circumferential search to determine a veiling effect in a depth map generated from a time-of-flight sensor. The method includes determining a starting cell within the depth map having a maximum signal value; generating a first boundary region comprising cells adjacent to the starting cell; calculating a first ratio corresponding to a number of cells within the first boundary region having a range value within a first threshold value and a total number of cells within the first boundary region; generating a next boundary region comprising cells adjacent to the first boundary region in response to the first ratio being above a second threshold; and stopping the pseudo-circumferential search in response to the first ratio being below a second threshold, wherein the total number of cells within a penultimate boundary region is used to determine a veiling glare effect.

In a first implementation form of the method according to the second aspect as such, the method further includes calculating a second ratio corresponding to a number of cells within the next boundary region having a range value within the first threshold value and a total number of cells within the next boundary region; generating a third boundary region comprising cells adjacent to the next boundary region in response to the second ratio being above the second threshold; and stopping the pseudo-circumferential search in response to the second ratio being below the second threshold.

In a second implementation form of the method according to the second aspect as such or any preceding implementation form of the second aspect, determining a flatness measurement for each boundary region, wherein the veiling glare effect is determined based on the flatness measurement and the total number of cells within the penultimate boundary region.

In a third implementation form of the method according to the second aspect as such or any preceding implementation form of the second aspect, the method further includes calculating a confidence measurement value based on the flatness measurement and the total number of cells within the penultimate boundary region to determine the veiling glare effect.

In a fourth implementation form of the method according to the second aspect as such or any preceding implementation form of the second aspect, the flatness measurement is determined by calculating an R-squared value for the cells within each boundary region.

In a fifth implementation form of the method according to the second aspect as such or any preceding implementation form of the second aspect, the method further includes calculating an upper boundary and a lower boundary for each boundary region, wherein the first threshold is determined based on the upper boundary and the lower boundary.

In a sixth implementation form of the method according to the second aspect as such or any preceding implementation form of the second aspect, the lower boundary is set to a maximum of a previous lower boundary or, in response to a radial distance from the starting cell equaling one, a spot range, or a mean range for the boundary region. The upper boundary is set to the minimum a pre-defined merging distance or a mean range of an nth percentile of cells for the boundary region, where n is greater than one.

A third aspect relates to a method for flatness measurement to determine a veiling effect in a depth map generated from a time-of-flight sensor. The method includes determining a starting cell within the depth map having a maximum signal value; generating a first boundary region comprising cells adjacent to the starting cell; calculating a first flatness measurement for the first boundary region; generating a next boundary region comprising cells adjacent to the first boundary region; calculating a second flatness measurement for the next boundary region, wherein each flatness measurement is calculated based on a mean range value and a normalized error value for cells within a respective boundary region; and calculating a total flatness measurement to determine a veiling glare effect.

In a first implementation form of the method according to the third aspect as such, the method further includes performing a pseudo-circumferential search. The pseudo-circumferential search includes calculating a first ratio corresponding to a number of cells within the first boundary region having a range value within a first threshold value and a total number of cells within the first boundary region; generating a next boundary region comprising cells adjacent to the first boundary region in response to the first ratio being above a second threshold; and stopping the pseudo-circumferential search in response to the first ratio being below a second threshold, wherein the total number of cells within a penultimate boundary region and the total flatness measurement is used to determine the veiling glare effect.

In a second implementation form of the method according to the third aspect as such or any preceding implementation form of the third aspect, the pseudo-circumferential search further includes calculating a second ratio corresponding to a number of cells within the next boundary region having a range value within the first threshold value and a total number of cells within the next boundary region; generating a third boundary region comprising cells adjacent to the next boundary region in response to the second ratio being above the second threshold; and stopping the pseudo-circumferential search in response to the second ratio being below the second threshold.

In a third implementation form of the method according to the third aspect as such or any preceding implementation form of the third aspect, the method further includes calculating a confidence measurement value based on the total flatness measurement and the total number of cells within the penultimate boundary region to determine the veiling glare effect.

In a fourth implementation form of the method according to the third aspect as such or any preceding implementation form of the third aspect, the pseudo-circumferential search further includes calculating an upper boundary and a lower boundary for each boundary region. The first threshold is determined based on the upper boundary and the lower boundary.

In a fifth implementation form of the method according to the third aspect as such or any preceding implementation form of the third aspect, the lower boundary is set to a maximum of a previous lower boundary or, in response to a radial distance from the starting cell equaling one, a spot range or a mean range for the boundary region. The upper boundary is set to the minimum a pre-defined merging distance or a mean range of an nth percentile of cells for the boundary region, where n is greater than one.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include processes, machines, manufacture, compositions of matter, means, methods, or steps within their scope.

The specification and drawings are, accordingly, to be regarded simply as an illustration of the disclosure as defined by the appended claims, and are contemplated to cover all modifications, variations, combinations, or equivalents that fall within the scope of the present disclosure.

What is claimed is:

1. A method for object abstraction to distinguish between different objects in a depth map generated from a time-of-flight sensor, the method comprising:
conducting a raster or spiral search on the depth map, the raster search comprising alternating between sweeping left to right and then up and down systematically, the spiral search comprising a circumferential-direction scanning;
detecting edges of an object to guide a continuation of the raster or spiral search;
calculating one or more high-level parameters related to the object; and
repeating the raster or spiral search for cells of the depth map that have not been previously swept to similarly identify other objects.

2. The method of claim 1, wherein the one or more high-level parameters of the object comprises a center, a size, a minimum range, a median range, a maximum range, a reflectance, or a combination thereof.

3. The method of claim 1, further comprising, for each raster or spiral search, determining a starting cell within the depth map not previously scanned and with the lowest range value.

4. The method of claim 3, wherein the raster search comprises scanning horizontally and vertically across the depth map starting from the starting cell, and wherein the spiral search comprises a circumferential-direction scanning from the starting cell.

5. The method of claim 4, wherein the raster search comprises shifting from the horizontal scan to the vertical scan in response to determining that a range value of a cell is above a threshold value and reverting to a previous cell before shifting to the vertical scan, and wherein the spiral search comprises shifting around a circle or outwards in a shape of a spiral from one cell to a next in response to determining that a range value of a cell is within the threshold value compared to surrounding cells.

6. The method of claim 4, wherein the raster search comprises shifting from the vertical scan to the horizontal scan in response to determining that a range value of a cell is above a threshold value and reverting to a previous cell before shifting to the horizontal scan, and wherein the spiral search comprises shifting around a circle or outwards in a shape of a spiral from one cell to a next until all scanned edge cells are determined to exceed a threshold value.

7. The method of claim 1, further comprising applying different threshold values to remove veiling glare effect for each object identified.

8. A method for pseudo-circumferential search to determine a veiling effect in a depth map generated from a time-of-flight sensor, the method comprising:
determining a starting cell within the depth map having a maximum signal value;
generating a first boundary region comprising cells adjacent to the starting cell;
calculating a first ratio corresponding to a number of cells within the first boundary region having a range value within a first threshold value and a total number of cells within the first boundary region;
generating a next boundary region comprising cells adjacent to the first boundary region in response to the first ratio being above a second threshold; and
stopping the pseudo-circumferential search in response to the first ratio being below a second threshold, wherein the total number of cells within a penultimate boundary region is used to determine a veiling glare effect.

9. The method of claim 8, further comprising:
calculating a second ratio corresponding to a number of cells within the next boundary region having a range value within the first threshold value and a total number of cells within the next boundary region;
generating a third boundary region comprising cells adjacent to the next boundary region in response to the second ratio being above the second threshold; and
stopping the pseudo-circumferential search in response to the second ratio being below the second threshold.

10. The method of claim 8, further comprising:
determining a flatness measurement for each boundary region, wherein the veiling glare effect is determined based on the flatness measurement and the total number of cells within the penultimate boundary region.

11. The method of claim 10, further comprising calculating a confidence measurement value based on the flatness measurement and the total number of cells within the penultimate boundary region to determine the veiling glare effect.

12. The method of claim 10, wherein the flatness measurement is determined by calculating an R-squared value for the cells within each boundary region.

13. The method of claim 8, further comprising calculating an upper boundary and a lower boundary for each boundary region, wherein the first threshold is determined based on the upper boundary and the lower boundary.

14. The method of claim 13,
wherein the lower boundary is set to a maximum of:
a previous lower boundary or, in response to a radial distance from the starting cell equaling one, a spot range, or
a mean range for the boundary region, and
wherein the upper boundary is set to the minimum:
a pre-defined merging distance, or
a mean range of an n^{th} percentile of cells for the boundary region, where n is greater than one.

15. A method for flatness measurement to determine a veiling effect in a depth map generated from a time-of-flight sensor, the method comprising:
determining a starting cell within the depth map having a maximum signal value;
generating a first boundary region comprising cells adjacent to the starting cell;
calculating a first flatness measurement for the first boundary region;
generating a next boundary region comprising cells adjacent to the first boundary region;
calculating a second flatness measurement for the next boundary region, wherein each flatness measurement is calculated based on a mean range value and a normalized error value for cells within a respective boundary region; and
calculating a total flatness measurement to determine a veiling glare effect.

16. The method of claim 15, further comprising performing a pseudo-circumferential search, the pseudo-circumferential search comprising:
calculating a first ratio corresponding to a number of cells within the first boundary region having a range value within a first threshold value and a total number of cells within the first boundary region;
generating a next boundary region comprising cells adjacent to the first boundary region in response to the first ratio being above a second threshold; and
stopping the pseudo-circumferential search in response to the first ratio being below a second threshold, wherein the total number of cells within a penultimate boundary region and the total flatness measurement is used to determine the veiling glare effect.

17. The method of claim 16, wherein the pseudo-circumferential search further comprises:
calculating a second ratio corresponding to a number of cells within the next boundary region having a range value within the first threshold value and a total number of cells within the next boundary region;
generating a third boundary region comprising cells adjacent to the next boundary region in response to the second ratio being above the second threshold; and
stopping the pseudo-circumferential search in response to the second ratio being below the second threshold.

18. The method of claim 16, further comprising calculating a confidence measurement value based on the total flatness measurement and the total number of cells within the penultimate boundary region to determine the veiling glare effect.

19. The method of claim 16, wherein the pseudo-circumferential search further comprises calculating an upper boundary and a lower boundary for each boundary region, wherein the first threshold is determined based on the upper boundary and the lower boundary.

20. The method of claim 19,
wherein the lower boundary is set to a maximum of:
a previous lower boundary or, in response to a radial distance from the starting cell equaling one, a spot range, or
a mean range for the boundary region, and
wherein the upper boundary is set to the minimum:
a pre-defined merging distance, or
a mean range of an n^{th} percentile of cells for the boundary region, where n is greater than one.
